(19) United States
(12) Patent Application Publication
(10) Pub. No.: US 2024/0126809 A1
(43) Pub. Date: Apr. 18, 2024

(54) SYSTEMS AND METHODS FOR ORGANIZING AND SEARCHING A VIDEO DATABASE

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, Canton, GA (US)

(73) Assignee: OP Solutions, LLC, Amherst, MA (US)

(21) Appl. No.: 18/542,866

(22) Filed: Dec. 18, 2023

Related U.S. Application Data
(63) Continuation of application No. PCT/US2002/033725, filed on Oct. 19, 2002.
(60) Provisional application No. 63/214,126, filed on Jun. 23, 2021.

(51) Int. Cl. G06F 16/71; G06F 16/735

(52) U.S. Cl. CPC G06F 16/71; G06F 16/735

(57) ABSTRACT

A system for organizing and searching a video database includes a logic circuit configured to extract, from a video, at least a video feature, generate at least a first hash value as a function of the at least a video feature, wherein generating the at least a first hash value further comprises performing a robust hash algorithm on the at least a feature, and store the video in a data structure, wherein storing the video further includes storing a representation of the video in a leaf node of the data structure and storing the at least a first hash value in a traversal index linking hash values to leaf nodes.

### CROSS-REFERENCE TO RELATED APPLICATIONS

This application is a continuation of international application Ser. No. PCT/US2022/033725, filed on Jun. 16, 2022, and entitled SYSTEMS AND METHODS FOR ORGANIZING AND SEARCHING A VIDEO DATABASE, which claims the benefit of priority to U.S. Provisional Application Ser. No. 63/214,126, filed on Jun. 23, 2021, and entitled SYSTEMS AND METHODS FOR ORGANIZING AND SEARCHING A VIDEO DATABASE, the disclosures of each of which are hereby incorporated by reference in there entireties.

### FIELD OF THE INVENTION

The present invention generally relates to the field of video encoding and decoding. In particular, the present invention is directed to systems and methods for organizing and searching a video database.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

A method for organizing and searching a video database is provided that extracts a video feature from a video signal and generates at least a first hash value as a function of the at least a video feature. Preferably, generating the at least a first hash value may be accomplished by performing a robust hash algorithm on the at least a feature. The method stores the video in a data structure, wherein storing the video further comprises storing a representation of the video in a leaf node of the data structure and storing the at least a first hash value in a traversal index linking hash values to leaf nodes.

In some embodiments, the traversal index can be configured to link vectors of hash values to leaf nodes. In some embodiments, storing the at least a first hash value in the traversal index further comprises arranging the at least a first hash value into a first vector and storing the first vector in a traversal index linking vectors to leaf nodes.

The method may be further include receiving at least a search feature, generating at least a second hash value using the at least a search feature and the robust hash algorithm, matching the at least a second hash value to the at least a first value in the traversal index, and locating the video as a function of the traversal index. In some embodiments, the matching may further include arranging the at least a second hash value into a second vector, and matching the second vector to a first vector containing the at least a first hash value using a vector similarity test.

In some embodiments, receiving the at least a search feature may also include receiving a query frame and extracting the at least a search feature from the query frame.

The present disclosure also include a system with logic and storage elements to implement the methods and database structures described herein.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a simplified block diagram illustrating an exemplary embodiment of a video coding and decoding system;

FIG. 2 is a simplified block diagram illustrating an exemplary embodiment of a video coding for machines system;

FIG. 3 is a block diagram illustrating an exemplary embodiment of a system for organizing and searching a video database;

FIG. 4 is a schematic diagram illustrating an exemplary embodiment of a video database;

FIG. 5 is a schematic diagram illustrating an exemplary embodiment of a video database constructed with a plurality of video features;

FIG. 6 is a schematic diagram illustrating an exemplary embodiment of a search traversal process;

FIG. 7 is a block diagram illustrating an exemplary embodiment of a video decoder;

FIG. 8 is a block diagram illustrating an exemplary embodiment of a video encoder;

FIG. 9 is a flow diagram illustrating an exemplary embodiment of a method of organizing and searching a video database, and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

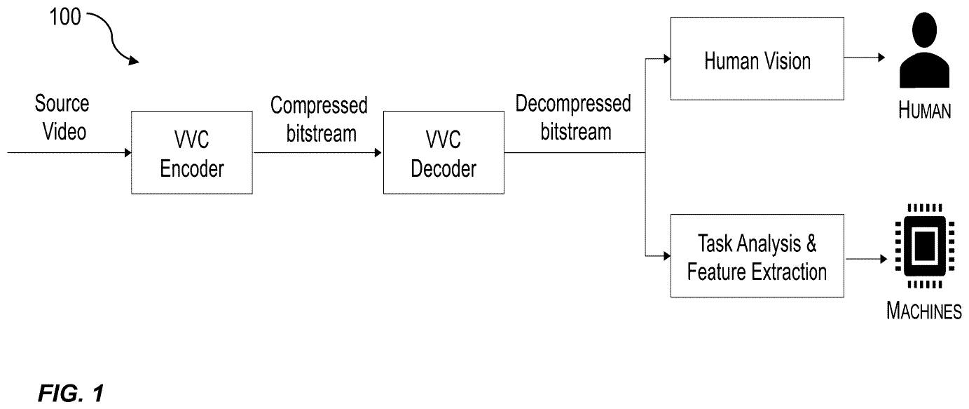

Embodiments described herein include systems and methods for organizing and searching video databases, for instance and without limitation, for videos coded using video coding for machines (VCM). In many applications, such as surveillance systems with multiple cameras, intelligent transportation, smart city applications, and/or intelligent industry applications, traditional video coding may require compression of large number of videos from cameras and transmission through a network to machines and for human consumption. Subsequently, at a machine site, algorithms for feature extraction may applied typically using convolutional neural networks or deep learning techniques including object detection, event action recognition, pose estimation and others. FIG. 1 shows an exemplary embodiment of a standard VVC coder applied for machines.

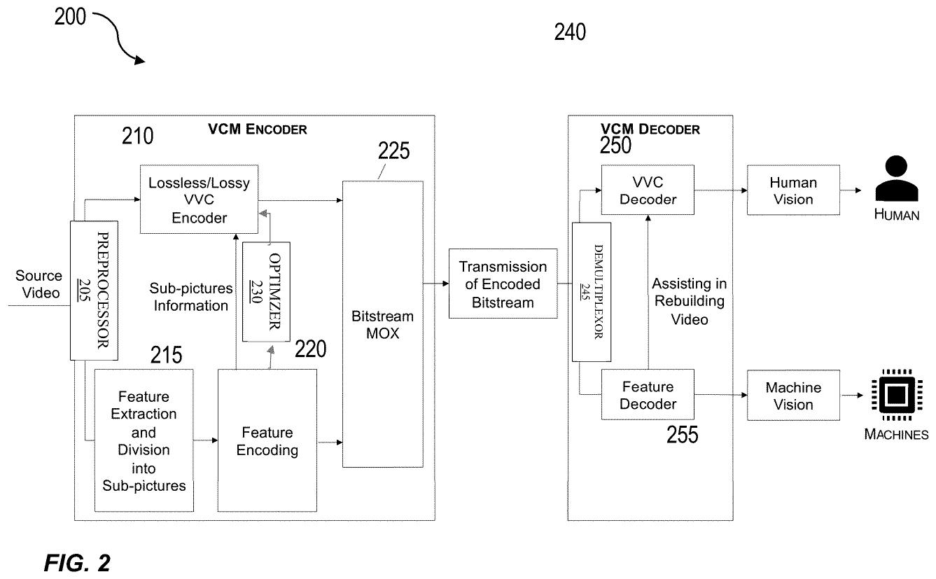

Conventional approaches may require a massive amount of video transmission from multiple cameras, which may take significant time and/or computational resources to enable efficient and fast real-time analysis and decision-making. In embodiments of the present disclosure, a VCM approach may resolve this problem by both encoding video and extracting some features at a transmitter site and then transmitting a resultant encoded bit stream to a VCM decoder. At a decoder site, video may be decoded for human vision and features may be decoded for machines. An exemplary embodiment of architecture which may be used in VCM encoding and decoding is shown in FIG. 2.

Referring now to FIG. 2, an exemplary embodiment of encoder for video coding for machines (VCM) is illustrated. VCM encoder may be implemented using any circuitry including without limitation digital and/or analog circuitry; VCM encoder may be configured using hardware configuration, software configuration, firmware configuration, and/or any combination thereof.

VCM encoder may be implemented as a computing device and/or as a component of a computing device, which may include without limitation any computing device as described below. In an embodiment, VCM encoder may be configured to receive an input or source video and generate an output bitstream. Reception of an input video may be accomplished in any manner described below. A bitstream may include, without limitation, any bitstream as described below.

Referring to FIG. 2, VCM encoder may include, without limitation, a pre-processor 205, a video encoder 210, a feature extractor 215, an optimizer 230, a feature encoder 220, and/or a multiplexor 225. Pre-processor 205 may receive input video stream and parse out video, audio and metadata sub-streams of the stream. Pre-processor 205 may include and/or communicate with decoder as described in further detail below; in other words, Pre-processor 205 may have an ability to decode input streams. This may allow, in a non-limiting example, decoding of an input video, which may facilitate downstream pixel-domain analysis.

Further referring to FIG. 2, VCM encoder may operate in a hybrid mode and/or in a video mode; when in the hybrid mode VCM encoder may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor.

Still referring to FIG. 2, video encoder may include without limitation any suitable video encoder 210 as described in further detail below. When VCM encoder is in hybrid mode, VCM encoder may send unmodified input video to video encoder 210 and a copy of the same input video, and/or input video that has been modified in some way, to feature extractor 215. Modifications to input video may include any scaling, transforming, or other modification that may occur to persons skilled in the art upon reviewing the entirety of this disclosure. For instance, and without limitation, input video may be resized to a smaller resolution, a certain number of pictures in a sequence of pictures in input video may be discarded, reducing framerate of the input video, color information may be modified, for example and without limitation by converting an RGB video might be converted to a grayscale video, or the like.

Still referring to FIG. 2, video encoder 210 and feature extractor 215 are preferably coupled and might exchange useful information in both directions. For example, and without limitation, video encoder 210 may transfer motion estimation information to feature extractor 215, and vice-versa. Video encoder 210 may provide Quantization mapping and/or data descriptive thereof based on regions of interest (ROI), which video encoder and/or feature extractor may identify, to feature extractor 215, or vice-versa. Video encoder 210 may provide to feature extractor 215 data describing one or more partitioning decisions based on features present and/or identified in input video, input signal, and/or any frame and/or subframe thereof; feature extractor may provide to video encoder data describing one or more partitioning decisions based on features present and/or identified in input video, input signal, and/or any frame and/or subframe thereof. Video encoder 210 and feature extractor 215 may share and/or transmit to one another temporal information for optimal group of pictures (GOP) decisions. Each of these techniques and/or processes may be performed, without limitation, as described in further detail below.

With continued reference to FIG. 2, feature extractor may operate in an offline mode or in an online mode. Feature extractor may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of- interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor by a remote machine in real time or at some point before extraction.

Still referring to FIG. 2, feature encoder 220 is configured for encoding a feature signal, for instance and without limitation as generated by feature extractor 215. In an embodiment, after extracting the features, feature extractor 215 may pass extracted features to feature encoder 220. Feature encoder 220 may use entropy coding and/or similar techniques, for instance and without limitation as described below, to produce a feature stream, which may be passed to multiplexor 225. Video encoder 210 and/or feature encoder 220 may be connected via optimizer (not shown). The optimizer may exchange useful information between the video encoder 210 and feature encoder 220. For example, and without limitation, information related to codeword construction and/or length for entropy coding may be exchanged and reused, via optimizer, for optimal compression.

In an embodiment, and continuing to refer to FIG. 2, video encoder 210 may produce an encoded video stream; video stream may be passed to multiplexor 225. Multiplexor 225 may multiplex video stream with a feature stream generated by feature encoder 220. Alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder is in video mode, VCM encoder 200 may use video encoder for both video and feature encoding. Feature extractor 215 may transmit features to video encoder 210 which may encode features into a video stream that may be decoded by a corresponding video decoder. It should be noted that VCM encoder 200 may use a single video encoder 210 for both video encoding and feature encoding, in which case it may use different set of parameters for video and features; alternatively, VCM encoder may two separate video encoders, which may operate in parallel.

Still referring to FIG. 2, system may include and/or communicate with, a VCM decoder 240. VCM decoder and/or elements thereof may be implemented using any circuitry and/or type of configuration suitable for configuration of VCM encoder as described above. VCM decoder may include, without limitation, a demultiplexor 245. Demultiplexor 245 may operate to demultiplex bitstreams if multiplexed as described above; for instance and without limitation, demultiplexor may separate a multiplexed bitstream containing one or more video bitstreams and one or more feature bitstreams into separate video and feature bitstreams.

Continuing to refer to FIG. 2, VCM decoder 240 may include a video decoder 250. Video decoder 250 may be implemented, without limitation in any manner suitable for a decoder as described in further detail below. In an embodiment, and without limitation, video decoder may generate an output video, which may be viewed by a human or other creature and/or device having visual sensory abilities.

Still referring to FIG. 2, VCM decoder may include a feature decoder 255. In an embodiment, and without limitation, feature decoder may be configured to provide one or more decoded data to a machine. Machine may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder 200 and/or VCM decoder 240 may be designed and/or configured to perform any method, method step, or sequence of method steps in any embodiment described in this disclosure, in any order and with any degree of repetition. For instance, each of VCM encoder and/or VCM decoder may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 200 and/or VCM decoder 240 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

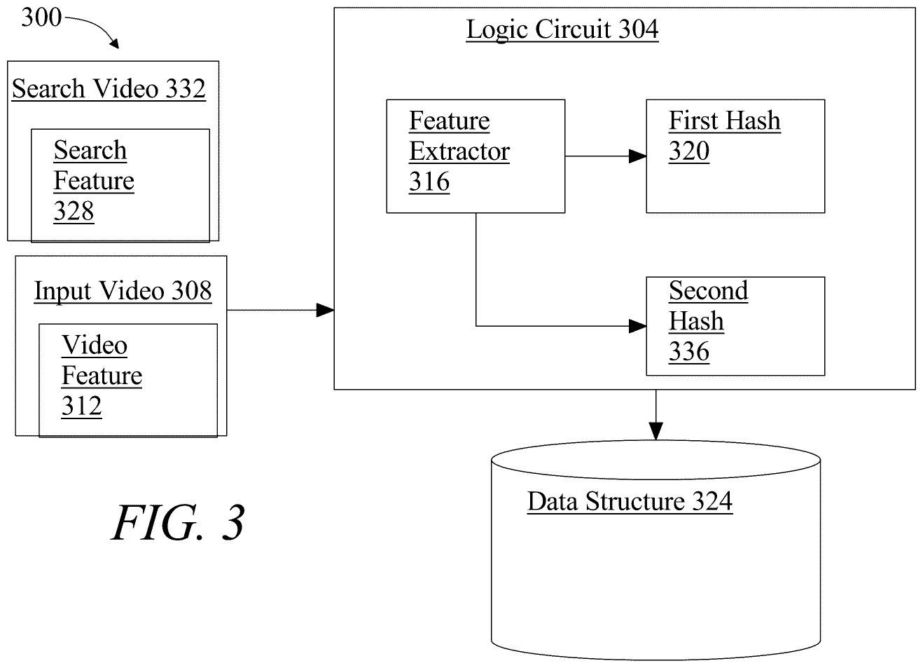

Referring now to FIG. 3, an exemplary embodiment of a system 300 for organizing and searching a video database is illustrated. System 300 includes a logic circuit 304. Logic circuit 304 may be implemented and/or configured using any combination of software and hardware configuration, including without limitation as an application-specific integrated circuit (ASIC), a field-programmable gate array (FPGA), or the like. Logic circuit 304 may include, without limitation, a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location.

Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of system 300 and/or computing device.

With continued reference to FIG. 3, logic circuit 304 may be designed and/or configured to perform any method, method step, or sequence of method steps in any embodiment described in this disclosure, in any order and with any degree of repetition. For instance, logic circuit 304 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Logic circuit 304 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In an embodiment, and still referring to FIG. 3, logic circuit 304 may be configured to extract at least a video feature 312 from a video. Input video 308 may include, without limitation, a series of pictures or frames, each of which may be represented and/or stored as a collection and/or array of luma and/or chroma values, for instance, and without limitation as described below. Logic circuit 304 may receive video in any suitable manner, including without limitation in the form of a video file, which may be transmitted, input, and/or received via any suitable network or other communication protocol. In a non-limiting example input video 308 may be received in the form of a bitstream, which logic circuit 304 and/or a decoder attached thereto may decode. Persons skilled in the art, upon reviewing the entirety of this disclosure, will be aware of various ways in which an input video 308 may be received consistently with this disclosure.

Still referring to FIG. 3, logic circuit 304 may include and/or communicate with a feature extractor 316, which may include without limitation any circuit and/or device configured to extract video feature 312. A “video feature 312,” as used in this disclosure, is a specific structural and/or content attribute of data. Examples of features may include SIFT, audio features, color hist, motion hist, speech level, loudness level, or the like. Features may be time stamped. Each video feature 312 may be associated with a single frame of a group of frames. Video feature 312 may include high level content video feature 312 such as timestamps, labels for persons and objects in the video, coordinates for objects and/or regions-of-interest, frame masks for region-based quantization, and/or any other video feature 312 that may occur to persons skilled in the art upon reviewing the entirety of this disclosure. As a further non-limiting example, video feature 312 may include video feature 312 that describe spatial and/or temporal characteristics of a frame or group of frames. Examples of video feature 312 that describe spatial and/or temporal characteristics may include motion, texture, color, brightness, edge count, blur, blockiness, or the like. Video feature 312 extractor may use one or more models to identify and extract video feature 312; models may include, without limitation, whole or partial convolutional neural networks, keypoint extractors, edge detectors, salience map constructors, or the like. When in online mode one or more models may be communicated to video feature 312 extractor by a remote machine in real time or at some point before extraction. As used in this disclosure, “extraction” does not necessarily imply removal from and/or alteration of a frame and/or video from which extraction is being performed; rather, extraction may include any identification of video feature 312 in situ within a video and/or video frame, and/or any process of parsing, copying, or otherwise obtaining data representing such video feature 312.

In an embodiment, and still referring to FIG. 3, extraction of video feature 312 may be performed in any suitable order. For instance, and without limitation, extraction may be performed in an order of traversal of the area or surface of a frame of input video 308, such as an order beginning at vertex, a geometric center, and/or any other point, and traversing in a prescribed order, such as horizontal, vertical, and/or diagonal traversal; traversal may occur in a wrapping scan similar to a video graphics array (VGA) scanning protocol, or the like, where traversal across a frame occurs in a chosen direction until an edge of the frame is reached, after which traversal wraps to an opposite edge, one unit down, and proceeds again in the previously selected direction of traversal. A “unit” of scanning, for these purposes, is an atomic unit to be traversed, which may include a pixel, luma, block, coding unit, coding tree unit, and/or any other unit of traversal. As a further non-limiting example, traversal may be performed by spiraling inward from a vertex and/or edge, spiraling outward from a center point, or the like. Traversal order and/or extraction order may alternatively or additionally follow any other order as described below. In an embodiment, extraction may be performed by a different component and/or device from logic circuit 304; in this case extracted video feature 312 and/or hashes thereof as described in further detail below may be transmitted to logic circuit 304. In an embodiment, the same traversal process may be performed for all images, so that hash values, hash feature vectors, or the like are readily comparable as described below.

With further reference to FIG. 3, logic circuit 304 may be configured to generate at least a first hash value 320 as a function of the at least a video feature 312. A “hash value,” or “hash,” as used in this disclosure, is a mathematical representation of a particular lot of data, such as a feature, which is known as a “message”; the hash may be referred to in some embodiments as a “digest.” For the avoidance of doubt, a “lot of data” as used herein refers a collection of data, regardless of size. Mathematical representation is generally produced by a lossy “one-way” algorithm known as a “hashing algorithm.” Hashing algorithm may be a repeatable process; that is, identical data input may produce identical hashes each time they are subjected to a particular hashing algorithm.

Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. A cryptographic hash, which is generally used for digital signatures or the like, may, dramatically changes when a single bit of the input message changes. This may occur due to an attribute of cryptographic hashing algorithms known as an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Polyl305-AES, Elliptic Curve Only Hash (“ECOH”) and similar hash functions, Fast- Syndrome-based (FSB) hash functions, GOST hash functions, the Grostl hash function, the HAS- 160 hash function, the JH hash function, the RadioGatUn hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2n/2) for n output bits; thus, it may take on the order of 2256 operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

In an embodiment, and still referring to FIG. 3, logic circuit 304 and/or another device may produce at least a first hash value 320 using a robust hash function. A “robust hash function,” as used in this disclosure, is a hash function that, in contrast to a cryptographic hash function is, does not produce an avalanche effect, and thus produces similar values for inputs resulting from a set of admissible transformations like compression that do not modify the fundamental hash features of a signal. In the context of image processing, robust hashing may generate similar hash values and/or set of hash values, such as hash feature vectors as described above, for visually equivalent images, evincing “robustness,” while resulting in distinct vectors for two different images evincing “discriminating capabilities.” As a consequence, a comparison of hash values and/or hash feature vectors computed by a robust hashing algorithm may indicate whether corresponding images are equivalent or not, independently of non-significant distortions due to common manipulation like compression or resampling. Exemplary descriptions of robust hashing algorithms and models are known and described, for example, in “Robust Hashing for Models,” Martinez et al., MODELS 2018, Oct. 14-19, 2018, Copenhagen, Denmark and “Robust Video Hashing Based on Radial Projections of Key Frames,” Roover et al., IEEE Transactions on Signal Processing, Vol. 53, No. 10, October 2005.

In an embodiment, a robust hashing algorithm may produce an extracted hash feature vector having good discriminating capabilities. Specifically, an appropriate detector may be able to identify pairs of distinct images based on a sole comparison of their hash feature vectors. Extracted hash features may be robust toward image processing operations that do not dramatically change a visual appearance of an image. Here, robustness may signify that an extracted hash feature vector is not significantly affected by visually imperceptible distortions of an input image so that a detector of distinct pairs of images may infer that hash feature vectors derived from original or processed images correspond to the same visual content. Typical image processing operations may include blurring, compression, and/or geometric manipulations such as scaling and rotation.

With continued reference to FIG. 3, at least a first hash value 320 may include a vector of hash values, each hash value of which may correspond to a hash feature of one or more hash features. A “vector” as defined in this disclosure is a data structure 324 that represents one or more a quantitative values and/or measures, known as elements, such as without limitation hash values. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3].Vectors may be more similar where their directions are more similar, and more different where their directions are more divergent, for instance as measured using cosine similarity as computed using a dot product of two vectors. Vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm: 1=\sqrt{Σᵢⁿaᵢ²}, where ai is attribute number i of the vector. Scaling and/or normalization may function to make vector comparison independent of absolute quantities of attributes, while preserving any dependency on similarity of attributes.

In an embodiment, and still referring to FIG. 3, a robust hashing algorithm may be performed by considering a projection of image pixels along a beam of lines passing through an image center, where the image may be without limitation a current frame of an input video 308, as characterized by their angular orientation. In an embodiment, components of a hash feature vector, or in other words of a vector of hash values, may be computed on a set of lines articulated around a center of an image, such as without limitation a geometric center thereof. Any number of lines may be used, such as without limitation 180 lines, which may correspond to an equal number of angles, which may be an evenly spaced set of angles; for instance, where 180 lines are used, an evenly spaced set of 180 angles ϕ, may be employed, with 0°5 ϕ 5 180°; for the sake of clarity, examples which follow may discuss 180 lines and angles, but a person skilled in the art having the benefit of the entirety of this disclosure will be aware of various alternative numbers of lines and angles that may be selected.

In an embodiment, and without limitation, for each projection angle, a hash feature sample ay be defined as a variance of pixel luminance values along the corresponding line; for other traversal techniques, an area such as a block, line of traversal, slice, or other region and/or sub- picture may be used, and moreover chroma, luma, and/or other measures of variance may be employed, along with any suitable mathematical functions thereof, such as discrete cosine transforms or the like.

Still referring to FIG. 3, Γ may denote a set of pixels (x, y) that are located on a projection and/or other sub-region as described above; for instance, in the example described above, Γ(ϕ) may denote a set of pixels (x, y) that are located on a projection line corresponding to a given angle ϕ. Further continuing the illustrative example, (xr, yr) may denote coordinates of a central pixel; in an exemplary embodiment it may be characterized that (x, y) ∈Γ(ϕ) if and only if

$$- \frac{1}{2} \leq ( x - {x}^{′} ) \cdot cos ( ϕ ) + ( y - {y}^{′} ) \cdot sin ( ϕ ) \leq \frac{1}{2}$$

Further referring to FIG. 3, and continuing the above-described example, letting I(x, y) denote the luminance value of pixel contained in a projection, a projected hash feature vector P(ϕ), 0°≤ϕ≤180° may be defined by

$$P ( ϕ ) = \frac{{\sum }_{( x , y ) ∈ Γ ( ϕ )} {I}^{2} ( x , y )}{♯ Γ ( ϕ )} - {( \frac{{\sum }_{( x , y ) ∈ Γ ( ϕ )} I ( x , y )}{♯ Γ ( ϕ )} )}^{2}$$

A sample P(ϕ) is may thus represent a variance of pixels' luminance on a line passing through the center of the image and whose orientation is defined by the ϕ angle; sample P may more generally be defined as the variance of pixel's luminance over an ordering and/or topology defined over a sub-picture or other region of consideration as described above. A hash feature vector, which may be denoted R, or in the case of the projections per angle ϕ as described above R(ϕ), may then be defined as a centered and normalized version of a projected vector P or P(ϕ), 0° ≤ϕ180°.

Letting μ and σ, respectively, denote the mean and standard deviation of a projected

vector, this may be defined as

$$R ( ϕ ) = , \frac{( ( P ( ϕ ) - μ ) )}{σ} ,$$

0°≤ϕ≤180° respectively. Depending on a sample set chosen, a hash feature vector may contain partly redundant information.

Still referring to FIG. 3, production of an image digest may include, without limitation, taking a discrete cosine transform (DCT) or similar operation of a hash feature vector as described above.

DCT may act to decorrelate hash feature samples; this may have the results that components of a hash feature vector that contain most of its energy may be emphasized to preserve its discriminating capabilities which are not significantly affected by small distortion of input image, and to increase robustness. Image hash may be based, in a non-limiting example, on some number, such as approximately 40, low-frequency DCT coefficients of a hash feature vector. For instance, and without limitation, a for a hash feature vector R(ϕ), with 0°≤ϕ≤180°, image digest coefficients, which may be denoted D(n),1≤n≤40, may be defined by

$$D ( n ) = \sqrt{\frac{2}{N} \cdot {\sum }_{ϕ = 0}^{N - 1} ( R ( ϕ ) \cdot cos ( \frac{π \cdot ( 2 ϕ + 1 \} \cdot n}{2 N} ) )}$$

where, 1≤n≤40, N=180. In practice, each coefficient may be quantized on some number of bits, such as 8 bits, so that a quantization noise may remain negligible in front of noise due to common image processing manipulations. This may result, as a non-limiting example, in a 320-bit image digest.

Alternatively or additionally, and continuing to refer to FIG. 3, any other consistently comparable numerical value and/or process for production thereof may be employed to represent hash features and/or populate hash feature vectors as contemplated in this disclosure. In an embodiment, a hashing process as described above may be performed for each sub-picture, region, or the like containing a video feature 312 of interest in current frame; in other words, traversal, sampling, and digest generation may be performed separately for a sub-picture and/or region corresponding to each such video feature 312.

In an embodiment, and further referring to FIG. 3, processes performed above may be performed per frame. Alternatively, processes may be performed for each block of a frame that contains a video feature 312 of interest. Such video features 312 may have been extracted, without limitation, using a VCM coder, including using user input to identify video feature 312 of interest, and/or one or more image classifiers, such as facial recognition software and/or circuitry.

Further referring to FIG. 3, logic circuit 304 may be configured to store video in a data structure 324. Data structure 324 may include, without limitation a database. A database may be implemented, without limitation, as a relational database, a key-value retrieval database such as a NOSQL database, or any other format or structure for use as a database that a person skilled in the art would recognize as suitable upon review of the entirety of this disclosure. A database may alternatively or additionally be implemented using a distributed data storage protocol and/or data structure 324, such as a distributed hash table or the like. A database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Storing video may include storing a representation of the video in a leaf node of the data structure 324, where “leaf node,” as used in this disclosure, is an element of data containing a representation of a video such as a leaf node of a tree if data structure 324 is a tree. A “representation” of a video is an element from which video and/or a frame thereof may be identified visually, in contrast to hash values, which are lossy and thus may not permit reconstruction of visual representations of video. Storing video may include storing at least a first hash value 320 in a traversal index linking hash values to leaf nodes. In an embodiment, traversal index may be configured to link vectors of hash values to leaf nodes; in other words, traversal index may be used to identify and/or retrieve input video 308.

Still referring to FIG. 3, storing at least a first hash value 320 in traversal index may include arranging the at least a first hash value 320 into a first vector. Vector elements may be ordered in extraction order and/or order of hashing; ordering of vector elements may be performed in any order suitable for either of those orders. First vector may be stored in a traversal index linking vectors to leaf nodes. Traversal index may include, without limitation a tree structure having internal nodes representing hashes as described above and including the leaf nodes, for instance and without limitation as described below. A tier ordering of the internal nodes may follow an element ordering of first vector, extraction order, hashing order, or any other suitable ordering.

Still referring to FIG. 3, system and/or logic circuit 304 may be configured to search data structure 324 based on a search query containing one or more video feature 312, frames, and/or other elements of a video. For instance, and without limitation, system and/or logic circuit 304 may be configured to receive at least a search feature 328; at least a search feature 328 may include without limitation any video feature 312 described above. System and/or logic circuit 304 may be configured to generate at least a second hash 336 value using the at least a search feature 328 and the robust hash algorithm; at least a second hash 336 may be generated in any manner suitable for generation of at least a first hash, including without limitation generation of a vector as described above. For instance, and without limitation, receiving at least a search feature 328 may include receiving a query frame; query frame may include any frame of any video as described above.

Receiving at least a search feature 328 may include extracting the at least a search feature 328 from a query frame. At least a search feature 328 may alternatively or additionally be extracted from a plurality of frames, such as a plurality of frames of a video provided as a query. With continued reference to FIG. 3, system and/or logic circuit 304 may be configured to match at least a second hash 336 value to at least a first value in traversal index and locate the video as a function of the traversal index. As a non-limiting example, matching may include arranging at least a second hash 336 value into a second vector and matching the second vector to a first vector containing at least a first hash value 320 using a vector similarity test. In an embodiment, where traversal index includes a tree structure having internal nodes representing feature hashes and including leaf nodes, vector similarity test may include matching each vector entry to a hash belonging to a set of nodes in a tier corresponding to the vector entry, where the set of nodes are child nodes of a previously matched parent node.

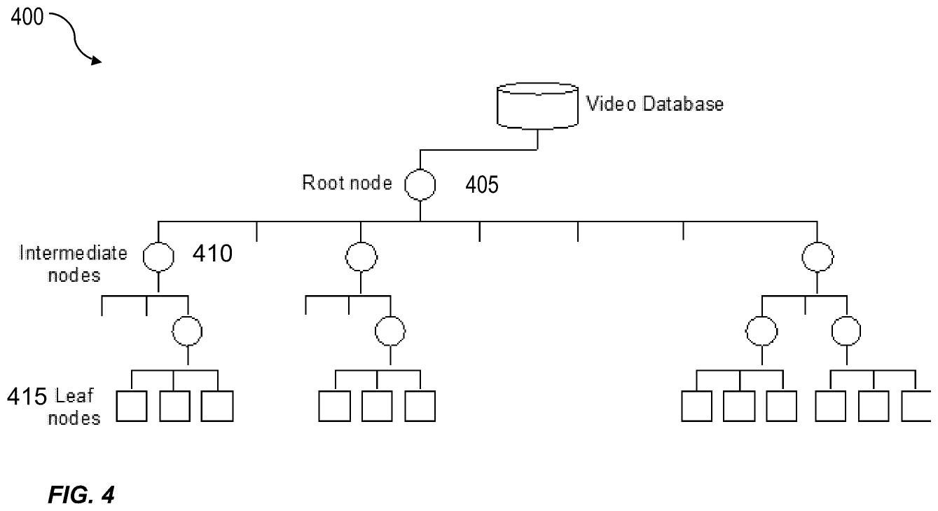

Referring now to FIG. 4 an exemplary embodiment of data structure 400 and/or video database is illustrated. Video database may be organized as a multi-dimensional video database that includes a root node 405, intermediate traversal nodes 410, and leaf nodes 415. To navigate around database and search for videos, a traversal index may be used. Leaf nodes may store associated data and associated indices related to videos in database. Traversal index may store differentiating information between different video frames. To find a video in database, a generated robust hash may be compared with hashes in traversal index. Robust hash may be defined, as described above as a hash value that will have similar hash feature vectors for visually equivalent images. As a consequence, comparison of image hash feature vectors computed by a robust hashing algorithm may indicate whether corresponding images are equivalent or not, independently of non- significant distortions due to common manipulation like compression or resampling.

Still referring to FIG. 4, root nodes 405 and intermediate nodes 410 may be organizational in nature; leaf nodes may be nodes containing database entries. A hash value may generally be computed from various hash features of a detailed signature of information within a region of interest, including and without limitation according to any process described above. Video indexing technologies including multidimensional index structures may, in an embodiment, permit efficient access to large-scale video archives.

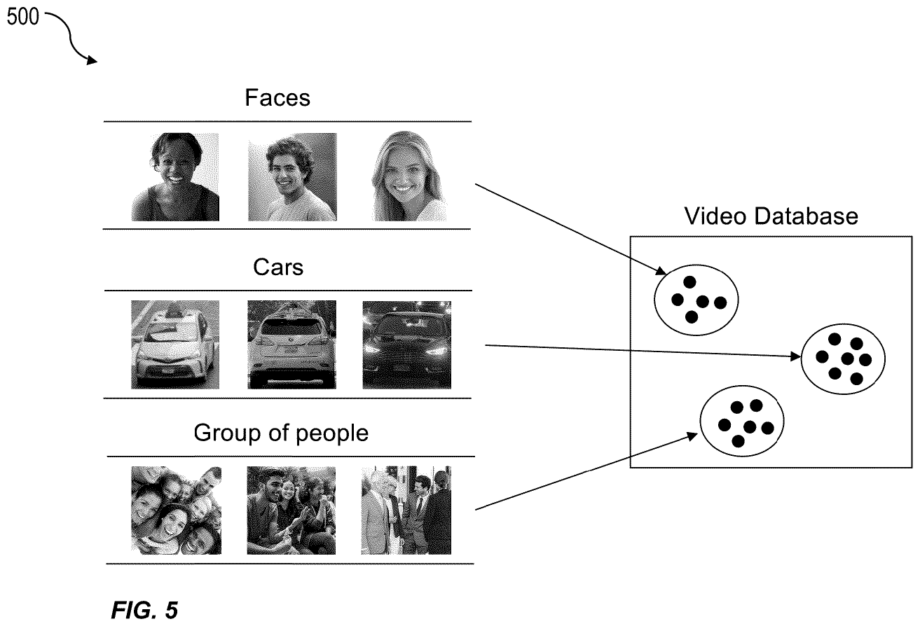

An example of a proposed approach is shown in FIG. 5. A video database may be constructed using videos where several video feature 312 in different video clips are extracted: as a non-limiting example, video features 312 may include faces, cars, groups of people, or the like.

Video features 312 may be extracted in videos using an encoder; video database may be organized based on these extracted video features 312. Hash values may be constructed based on these video features 312. For example, when searching for a face, a hash value and related query vector may be used to navigate through multi-dimensional database and find a leaf node 415 that has a video feature 312 most similar to the query vector.

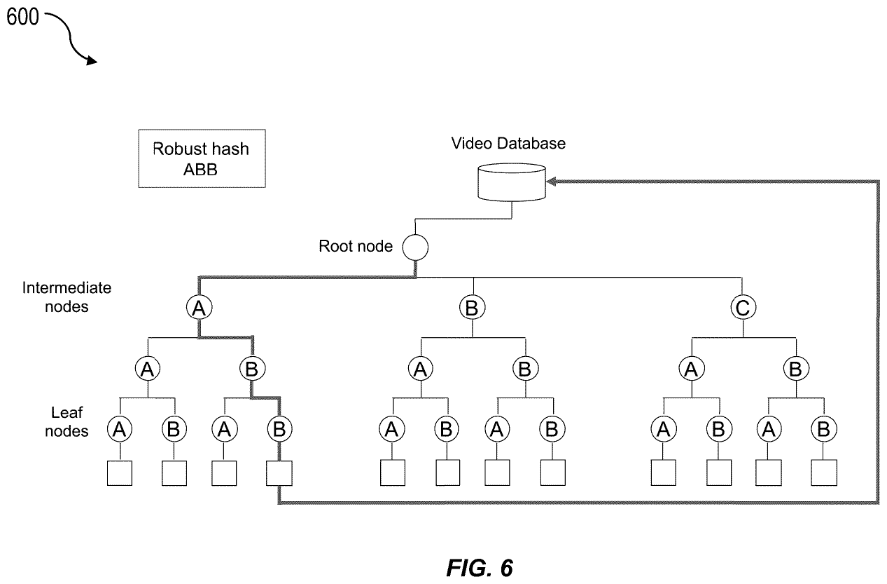

Referring now to FIG. 6, an exemplary embodiment of a process for searching for a video based on hash value, is illustrated, where a robust hash value is a function of a given video feature 312 and/or a block, CTU, coding unit, and/or other sub-picture and/or region containing the video feature 312 of interest. For instance, relating to the example in FIG. 5, if it is assumed that that all robust hash values for faces begin with value A, for cars with value B, and for group of people with value, various faces have the following robust hash values: AAA, AAB, ABA, ABB, and the like.

Exemplary robust hash values for cars may include: BAA, BAB, BBA, BAA, and the like, and for group of people robust hash values may include CAA, CAB, CBA, CBB, and the like. Hash value may be used as traversal index in video database from FIG. 5. For instance, where a search is for a face, query may extract its video feature 312 from a query frame and calculate its hash value; such as for illustrative purposes ABB. Hash value may be used as and/or with a transversal index and after traversing through multi-dimensional tree, a search algorithm may locate a leaf node, information about a matching video, such as a representation as described above, is stored. Searched video may then be retrieved and accessed. In embodiments, proposed organization and search of video databases using extracted video feature 312 may significantly accelerate searches and reduce a number of intermediate nodes that are traversed through the search.

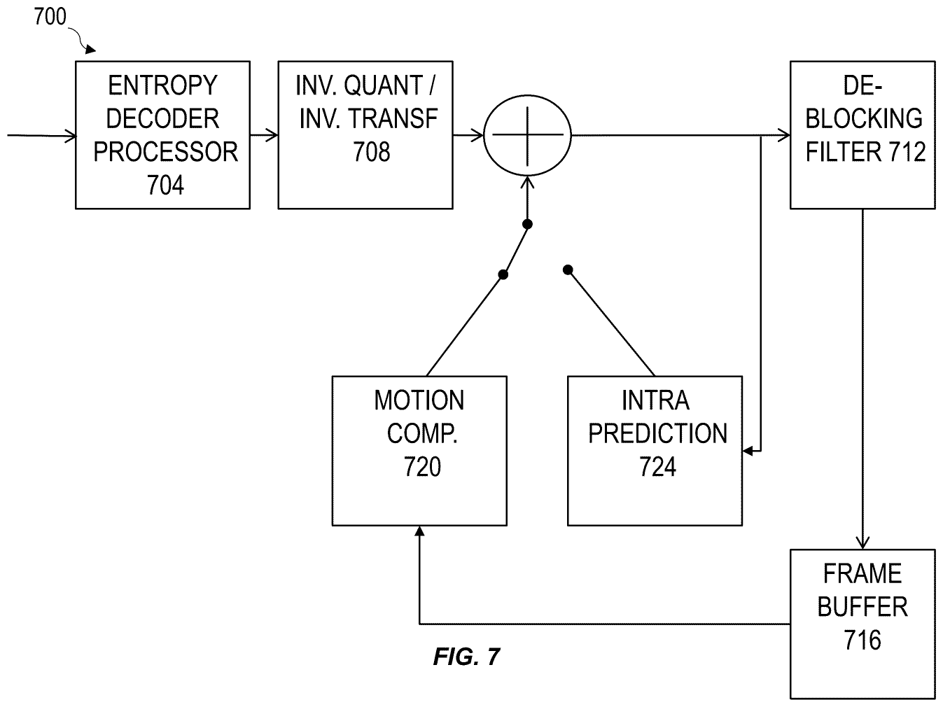

FIG. 7 is a system block diagram illustrating an example decoder suitable for use as video decoder 250 and/or feature decoder 255. Decoder 700 may include an entropy decoder processor 704, an inverse quantization and inverse transformation processor 708, a deblocking filter 712, a frame buffer 716, a motion compensation processor 720 and/or an intra prediction processor 724.

In operation, and still referring to FIG. 7, bit stream 728 may be received by decoder 700 and input to entropy decoder processor 704, which may entropy decode portions of bit stream into quantized coefficients. Quantized coefficients may be provided to inverse quantization and inverse transformation processor 708, which may perform inverse quantization and inverse transformation to create a residual signal, which may be added to an output of motion compensation processor 720 or intra prediction processor 724 according to a processing mode. An output of the motion compensation processor 720 and intra prediction processor 724 may include a block prediction based on a previously decoded block. A sum of prediction and residual may be processed by deblocking filter 712 and stored in a frame buffer 716.

In an embodiment, and still referring to FIG. 7 decoder 700 may include circuitry configured to implement any operations as described above in any embodiment as described above, in any order and with any degree of repetition. For instance, decoder 700 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

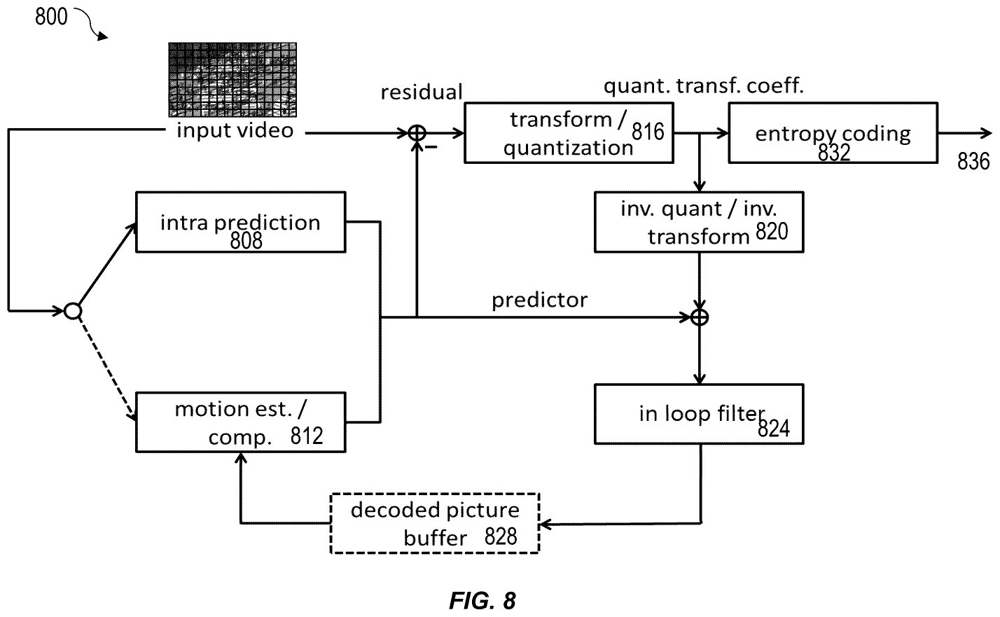

FIG. 8 is a system block diagram illustrating an example video encoder 800, suitable for use as video encoder 210 and/or feature encoder 220. Example video encoder 800 may receive an input video 804, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 8, example video encoder 800 may include an intra prediction processor 808, a motion estimation/compensation processor 812, which may also be referred to as an inter prediction processor, capable of constructing a motion vector candidate list including adding a global motion vector candidate to the motion vector candidate list, a transform/quantization processor 816, an inverse quantization / inverse transform processor 820, an in-loop filter 824, a decoded picture buffer 828, and/or an entropy coding processor 832. Bit stream parameters may be input to the entropy coding processor 832 for inclusion in the output bit stream 836.

In operation, and with continued reference to FIG. 8, for each block of a frame of input video 308, whether to process block via intra picture prediction or using motion estimation/compensation may be determined. Block may be provided to intra prediction processor 808 or motion estimation/compensation processor 812. If block is to be processed via intra prediction, intra prediction processor 808 may perform processing to output a predictor. If block is to be processed via motion estimation/compensation, motion estimation/compensation processor 812 may perform processing including constructing a motion vector candidate list including adding a global motion vector candidate to the motion vector candidate list, if applicable.

Further referring to FIG. 8, a residual may be formed by subtracting a predictor from input video 308. Residual may be received by transform/quantization processor 816, which may perform transformation processing (e.g., discrete cosine transform (DCT)) to produce coefficients, which may be quantized. Quantized coefficients and any associated signaling information may be provided to entropy coding processor 832 for entropy encoding and inclusion in output bit stream 836. Entropy encoding processor 832 may support encoding of signaling information related to encoding a current block. In addition, quantized coefficients may be provided to inverse quantization/ inverse transformation processor 820, which may reproduce pixels, which may be combined with a predictor and processed by in loop filter 824, an output of which may be stored in decoded picture buffer 828 for use by motion estimation/compensation processor 812 that is capable of constructing a motion vector candidate list including adding a global motion vector candidate to the motion vector candidate list.

With continued reference to FIG. 8, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 8, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 8, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 8, encoder 800 may include circuitry configured to implement any operations as described above in any embodiment, in any order and with any degree of repetition.

For instance, encoder 800 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 800 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 8, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 800 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

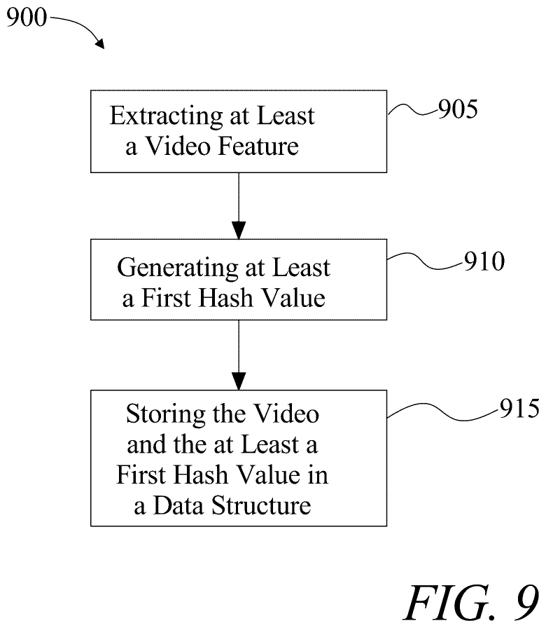

Referring now to FIG. 9, an exemplary embodiment of a method 900 of organizing and searching a video database is illustrated. At step 905, a logic circuit 304 extracts, from a video, at least a video feature 312; this may be implemented, without limitation, as described above in reference to FIGS. 1-8.

At step 910, logic circuit 304 generates at least a first hash value 320 as a function of at least a video feature 312. Generating at least a first hash value 320 includes performing a robust hash algorithm on the at least a video feature 312; this may be implemented, without limitation, as described above.

At step 915, logic circuit 304 storing the video in a data structure 324; this may be implemented, without limitation, as described above in reference to FIGS. 1-8. Storing video may include storing a representation of the video in a leaf node of data structure 324. Storing video may include storing at least a first hash value 320 in a traversal index linking hash values to leaf nodes.

In an embodiment, and still referring to FIG. 9, traversal index may be configured to link vectors of hash values to leaf nodes. Storing at least a first hash value 320 in traversal index may include arranging the at least a first hash value 320 into a first vector and storing the first vector in a traversal index linking vectors to leaf nodes, for instance and without limitation as described above in reference to FIGS. 4-6. In an embodiment, traversal index may include a tree structure having internal nodes representing hashes and including leaf nodes, and a tier ordering of the internal nodes may an element ordering of first vector; this may be implemented, without limitation, as described above in reference to FIGS. 4-6.

Still referring to FIG. 9, method 900 may include receiving at least a search feature 328, generating at least a second hash 336 value using the at least a search feature 328 and the robust hash algorithm, matching the at least a second hash 336 value to at least a first value in traversal index, and locating video as a function of the traversal index. This may be implemented, without limitation, as described above. The method may further include arranging at least a second hash 336 value into a second vector and matching the second vector to a first vector containing at least a first hash value 320 using a vector similarity test. In an embodiment, traversal index may include a tree structure having internal nodes representing feature hashes and including the leaf nodes. Vector similarity test may include matching each vector entry to a hash belonging to a set of nodes in a tier corresponding to the vector entry; the set of nodes may include and/or consist of child nodes of a previously matched parent node. This may be implemented, without limitation, as described above.

Receiving at least a search feature 328 may include receiving a query frame and extracting the at least a search feature 328 from the query frame. This may be implemented, without limitation, as described above.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine- readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

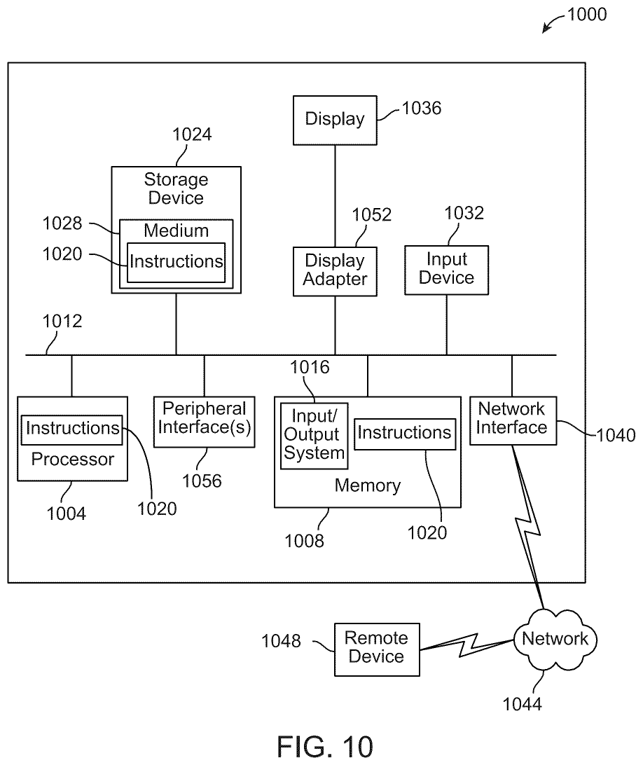

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC)

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha- numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of organizing and searching a video database, the method comprising: extracting, from a video, at least a video feature;
generating at least a first hash value as a function of the at least a video feature, wherein generating the at least a first hash value further comprises performing a robust hash algorithm on the at least a feature; and
storing the video in a data structure, wherein storing the video further comprises: storing a representation of the video in a leaf node of the data structure; and
storing the at least a first hash value in a traversal index linking hash values to leaf nodes.

2. The method of claim 1, wherein the traversal index is configured to link vectors of hash values to leaf nodes.

3. The method of claim 2, wherein storing the at least a first hash value in the traversal index further comprises:
arranging the at least a first hash value into a first vector; and
storing the first vector in a traversal index linking vectors to leaf nodes.

4. The method of claim 3, wherein the traversal index further comprises a tree structure having internal nodes representing feature hashes and including the leaf nodes, wherein a tier ordering of the internal nodes follows an element ordering of the first vector.

5. The method of claim 1, further comprising:
receiving at least a search feature;
generating at least a second hash value using the at least a search feature and the robust hash algorithm;
matching the at least a second hash value to the at least a first value in the traversal index; and
locating the video as a function of the traversal index.

6. The method of claim 4, wherein matching further comprises:
arranging the at least a second hash value into a second vector; and
matching the second vector to a first vector containing the at least a first hash value using a vector similarity test.

7. The method of claim 6, wherein the traversal index further comprises a tree structure having internal nodes representing feature hashes and including the leaf nodes, and the vector similarity test further comprises:
matching each vector entry to a hash belonging to a set of nodes in a tier corresponding to the vector entry, wherein the set of nodes are child nodes of a previously matched parent node.

8. The method of claim 4 where receiving the at least a search feature further comprises:
receiving a query frame; and
extracting the at least a search feature from the query frame.

9. A system for organizing and searching a video database, the system comprising a logic circuit configured to:
extract, from a video, at least a video feature;
generate at least a first hash value as a function of the at least a video feature, wherein generating the at least a first hash value further comprises performing a robust hash algorithm on the at least a feature; and
store the video in a data structure, wherein storing the video further comprises: storing a representation of the video in a leaf node of the data structure; and
storing the at least a first hash value in a traversal index linking hash values to leaf nodes.

10. The system of claim 9, wherein the traversal index is configured to link vectors of hash values to leaf nodes.

11. The system of claim 11, wherein storing the at least a first hash value in the traversal index further comprises:
arranging the at least a first hash value into a first vector; and
storing the first vector in a traversal index linking vectors to leaf nodes.

12. The system of claim 9, further configured to:
receive at least a search feature;
generate at least a second hash value using the at least a search feature and the robust hash algorithm;
match the at least a second hash value to the at least a first value in the traversal index; and locate the video as a function of the traversal index.

13. The system of claim 12, wherein matching further comprises:
arranging the at least a second hash value into a second vector; and
matching the second vector to a first vector containing the at least a first hash value using a vector similarity test.

14. The system of claim 12 wherein receiving the at least a search feature further comprises:
receiving a query frame; and
extracting the at least a search feature from the query frame.
